(19) United States
(12) Patent Application Publication
(10) Pub. No.: US 2021/0059882 A1
(43) Pub. Date: Mar. 4, 2021

(54) Portable Leg Lifting Assisting Assembly

(71) Applicant: Larry DeLance, Onawa, IA (US)

(72) Inventor: Larry DeLance, Onawa, IA (US)

(21) Appl. No.: 16/559,256

(22) Filed: Sep. 3, 2019

(51) Int. Cl. A61G 7/10

(52) U.S. Cl. CPC A61G 7/1096; A61G 7/1046; A61G 7/1017

(57) ABSTRACT

A portable leg lifting assisting assembly includes a base having a top side, a bottom side and a perimeter edge. A plurality of wheels is rotatably attached to the bottom side. A post having an upper end extends upwardly from the base. A support arm has a first end and a second end. The support arm is pivotally attached to the upper end of the post and pivots in a vertical plane extending through the first and second ends. A lift mechanism is coupled to the post and the support arm is actuated to lift the second end up or down relative to the base. A beam is attached to the support arm adjacent to the second end. A pair of saddles for receiving a person's legs is attached to the beam.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to movable leg lifting device and more particularly pertains to a new movable leg lifting device for assisting a caregiver in lifting the legs of a person who is non-ambulatory. Such a device is useful for taken care of a person who is otherwise bedridden.

### (2) Description of Related Art Including Information Disclosed Under 37 CFR 1.97 and 1.98

The prior art relates to movable leg lifting devices used for patients or person's otherwise bedridden.

### BRIEF SUMMARY OF THE INVENTION

An embodiment of the disclosure meets the needs presented above by generally comprising a base having a top side, a bottom side and a perimeter edge. The perimeter edge includes a front edge, a rear edge, a first lateral edge and a second lateral edges. A plurality of wheels is rotatably attached to and extends downwardly from the bottom side. A post is attached to and extends upwardly from the base. The post has an upper end. A support arm has a first end, a second end and an outer surface extending between the first and second ends. The support arm is pivotally attached to the upper end of the post. The support arm extends forward from the post. The post pivots in a vertical plane extending through the first and second ends. A lift mechanism is coupled to the post and the support arm is actuated to lift the second end up or down relative to the base. A beam is attached to the support arm adjacent to the second end. The beam is elongated and has a pair of outer ends. Each of a pair of cables is attached to the beam. The cables each have attached end and a free end. A pair of saddles is provided, wherein each saddle receives a leg. Each of the free ends has one of the saddles removably attached thereto.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of saddle components of a portable leg lifting assisting assembly according to an embodiment of the disclosure.

FIG. 2 is a front isometric view of an embodiment of the disclosure.

FIG. 3 is a side view of an embodiment of the disclosure.

FIG. 4 is a cross-sectional view of an embodiment of the disclosure taken along line 4-4 of FIG. 5.

FIG. 5 is a front perspective view of an embodiment of the disclosure.

### DETAILED DESCRIPTION OF THE INVENTION

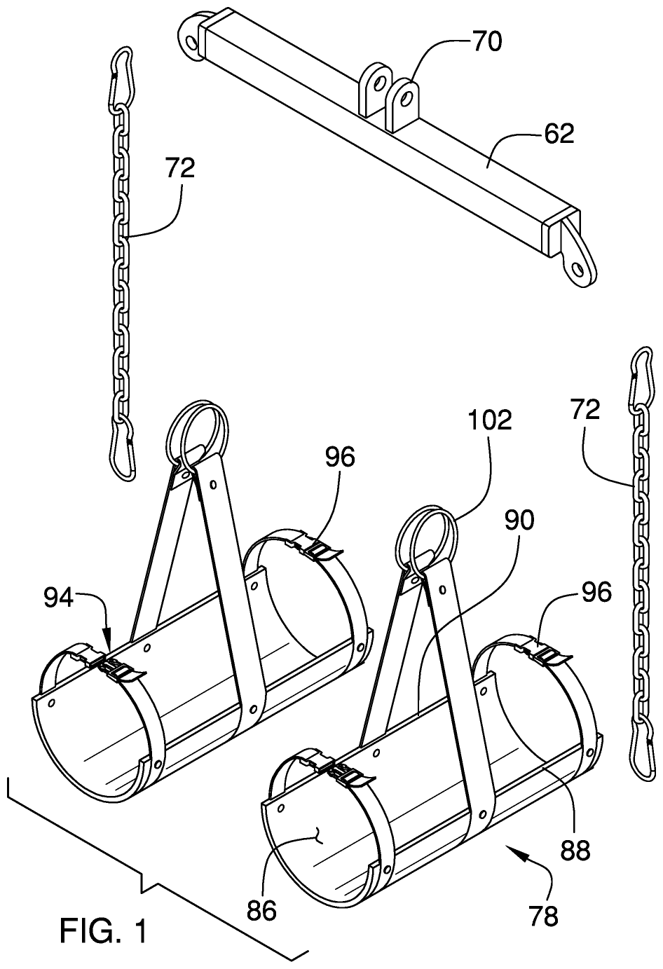

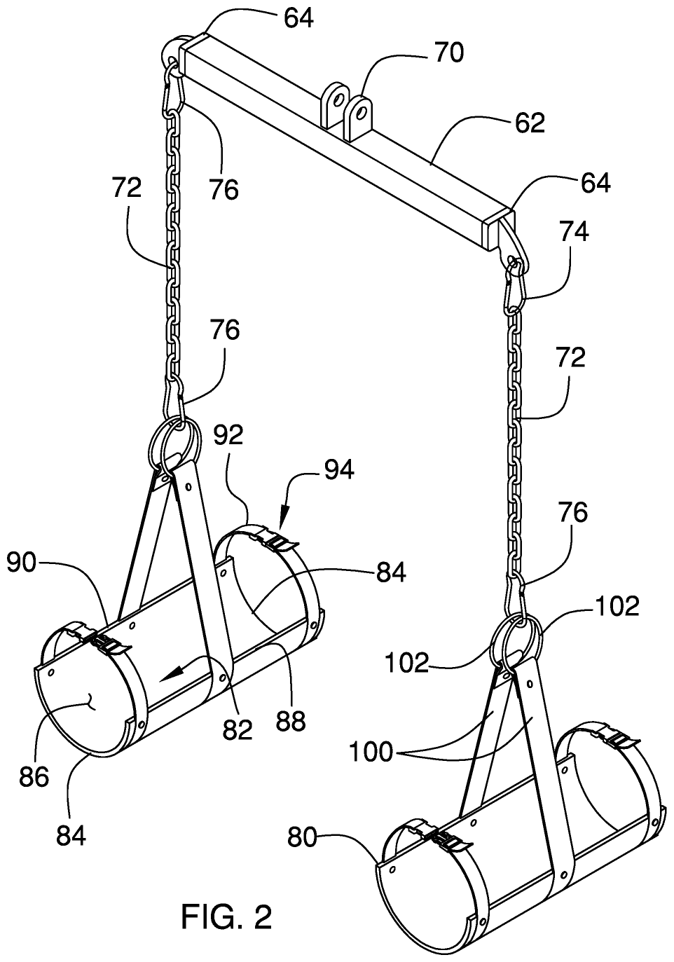

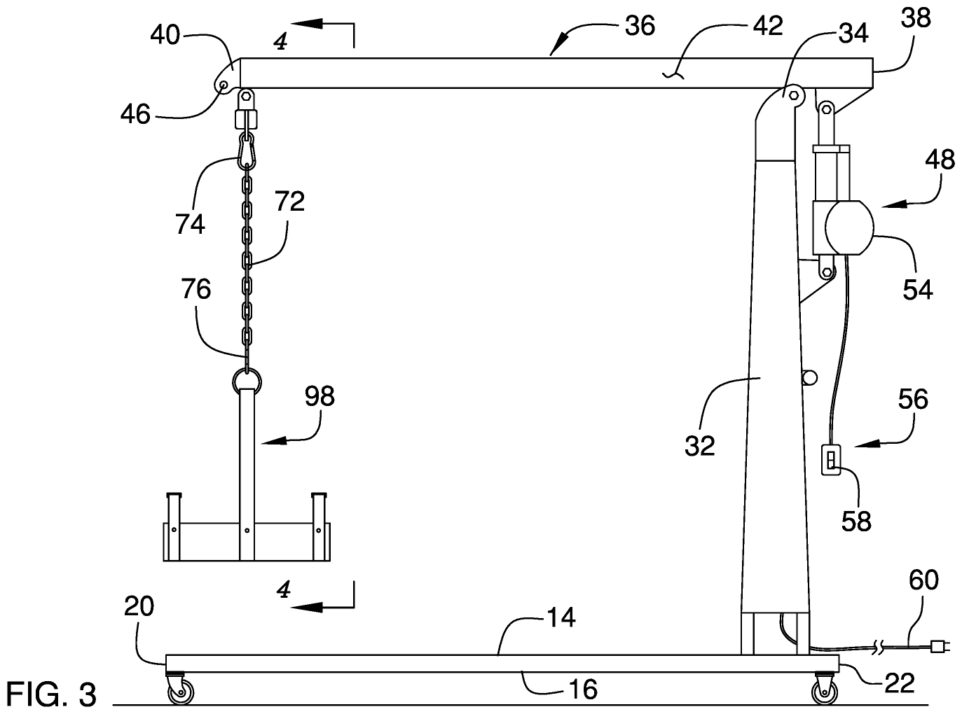

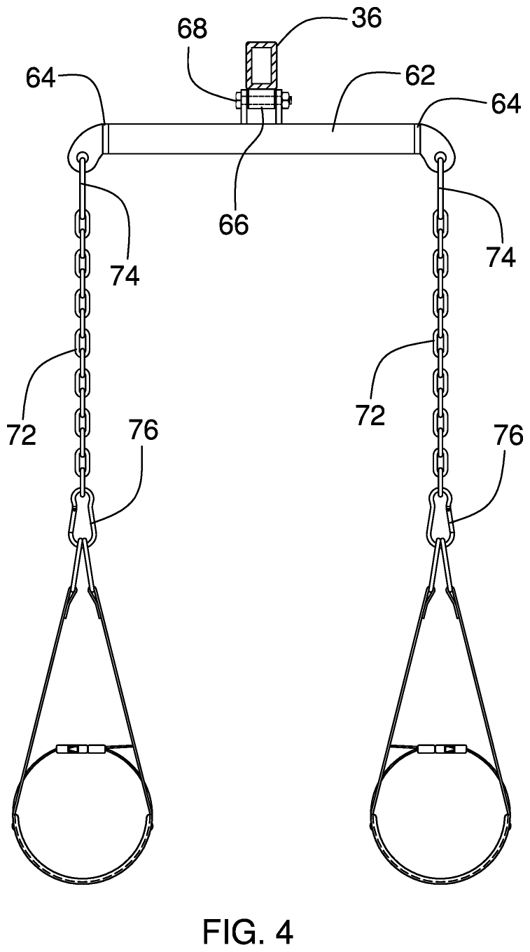

With reference now to the drawings, and in particular to FIGS. 1 through 5 thereof, a new movable leg lifting device embodying the principles and concepts of an embodiment of the disclosure and generally designated by the reference numeral 10 will be described.

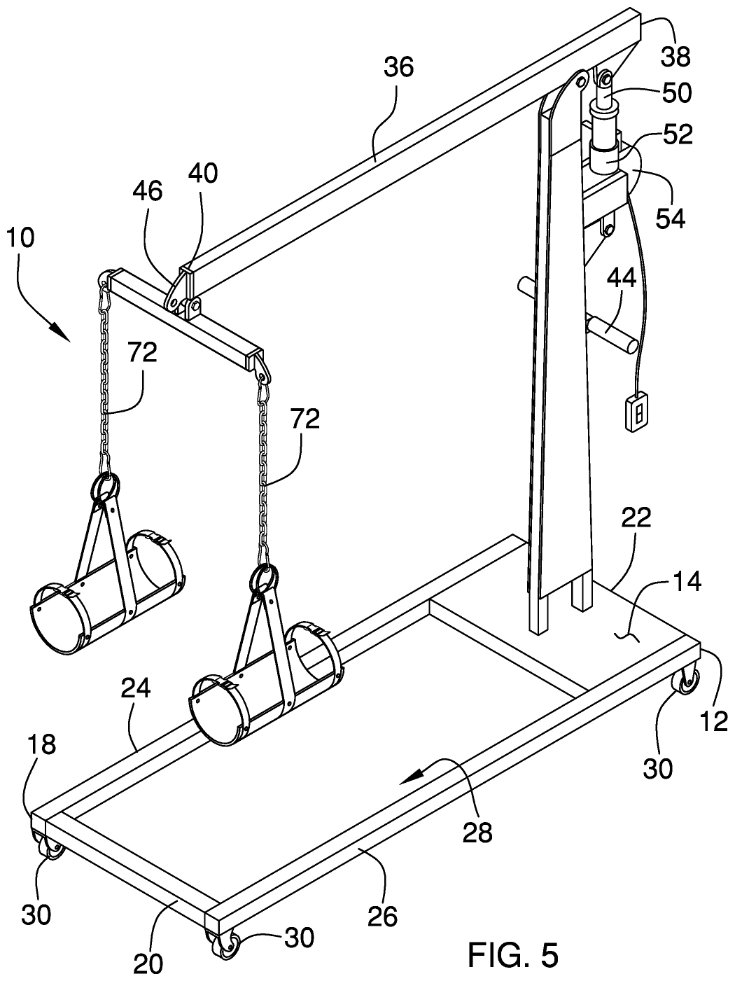

As best illustrated in FIGS. 1 through 5, the portable leg lifting assisting assembly 10 generally comprises a base 12 having a top side 14, a bottom side 16 and a perimeter edge 18. The perimeter edge 18 includes a front edge 20, a rear edge 22, a first lateral edge 24 and a second lateral edge 26. A distance between the front and rear edges is greater than 3.0 feet and may be up 7.0 feet. As can be seen in FIG. 5, the base 12 may include a frame having a large, centrally located open area 28 extending therethrough to facilitate a person's positioning within the base 12 while placing a person's legs into and out of the assembly 10. A plurality of wheels 30 is rotatably attached to and extends downwardly from the bottom side 16 to allow the assembly 10 to be moved where needed. A height from a bottom of the wheels 30 to the top side 14 is less than 6.0 inches to allow the base 12 to be rolled under furniture, such as a bed. One or more of the wheels 30 may be lockable.

A post 32 is attached to and extends upwardly from the base 12. The post 32 has an upper end 34 and has a height typically between 4.0 feet and 7.0 feet. The post 32 is positioned between the first 24 and second 26 lateral edges and adjacent to the rear edge 22. A support arm 36 has a first end 38, a second end 40 and an outer surface 42 extending between the first 38 and second 40 ends. The support arm 36 is pivotally attached to the upper end 34 of the post 32. The first end 38 is positioned adjacent to the post 32 so that the second end 40 of the support arm 36 extends forward and away from the post 32. The post 32 pivots in a vertical plane extending through the first 38 and second 40 ends such that the second end 40 moves nearer and further away from front edge 20 of the base 12. The support arm 36 extends at least 3.0 feet forwardly away from the post 32 but will typically extend at least 4.0 feet forwardly from the post 32. On a rear surface of the post is mounted a handle 44 for facilitating the movement of the assembly 10 over a ground surface. A catch 46 may be attached to the second end 40 for engaging hooks, ropes, tethers and the like as needed.

A lift mechanism 48 is coupled to the post 32 and the support arm 36. The lift mechanism 48 is electrically powered and is actuated to lift the second end 40 up or down relative to the base 12. While any number of lift mechanisms may be used including an electric motor coupled to one or more gears or belt and pulley systems coupled to an electric motor. However, in an embodiment shown in the Figures, a piston 50 is mounted to the post 32 and is extended from or withdrawn into a cylinder 52. This may be accomplished by an electric motor 54 coupled to the piston 50 by a rack and pinion combination or the usage of hydraulic or pneumatic forces. The piston 50 is attached to the support arm 36 at or near the first end 38 thereof. As the first end 38 is forced upwardly, the second end 40 will fall and the second end 40 is lifted when the first end 38 is pulled downwardly. A control 56 is electrically coupled to the electric motor 54 and includes a switch 58 used to turn on the electric motor 54 in a first direction lifting the piston 50 or in a second direction lowering the piston 50. The control 56 is electrically to a power supply which will typically include a power cord 60 that may be plugged into a standard electrical outlet though rechargeable batteries may instead be employed.

A beam 62 is attached to the support arm 36 adjacent to the second end 40. The beam 62 is elongated and has a pair of outer ends 64. The second end 40 is positioned between the outer ends 64 and the beam 62 is orientated perpendicular to a longitudinal axis of the support arm 36 extending through the first 38 and second 40 ends. As can be seen in the Figures, the support arm 36 may have a tube 66 attached thereto through which a pin 68 is extended. The pin 68 is also extended through a mount 70 on the beam 62 to removably couple the two together though the beam 62 may be permanently affixed to the support arm 36.

A pair of cables 72 is proved. Each of the cables 72 has an attached end 74 and a free end 76. As shown in the Figures, the cables 72 may comprise chains, however, the cables 72 may also include woven metallic cables, canvas strap material or other similar materials used to hang an object at fixed height and therefore are not limited by the specific construction thereof. A chain may be preferred as adjusting its length relative to the support arm 36 may be achieved by attaching the chain to the support arm 36 with a selected one of the links of the chain. Each of the attached ends 74 is attached removably to the beam 62 wherein one of the cables 72 is positioned adjacent to one of the outer ends 64 and one of the cables 72 is positioned adjacent to another one of the outer ends 64. Each of the attached 74 and free ends 76 may be comprised of a hook such as a carabiner type coupler.

A pair of saddles 78 is provided and each is configured to engage a leg of a person. The free ends 76 of the cables 72 each have one of the saddles 78 removably attached thereto. The saddles 78 each include a semi-cylindrical sleeve 80 having an open upper side 82 and a pair of open ends 84. The semi-cylindrical sleeve 80 is elongated and has upper surface 86 having an arcuate shape extending from a first side edge 88 to a second side edge 90. The size of the saddles 78 may be configured such that they can easily accommodate a particular's person's upper leg or calf. However, the semi-cylindrical sleeve 80 may be comprised of a resiliently flexible material such as plastics or elastomers which conform to the shape of the user's leg. A plurality of straps 92 extend over the upper side 82 and each strap 92 is configured to releasably retain a leg in the semi-cylindrical sleeve 80. The straps 92 each include a break 94 therein forming a pair of strap ends. A plurality of couplers 96 is provided and each of the straps 92, or strap ends, has one of the couplers 96 attached thereto to close the break 94 in a respective one of the straps 92. The couplers 96 may include slip connectors to allow a length of the straps 92 to be selectively altered. A connector 98 is attached to the semi-cylindrical sleeve 80 and is removably coupled to the free end 76 of one of the cables 72. The connector 98 may comprise a pair of tethers 100 extending upwardly from opposite sides of the semi-cylindrical sleeve 80. Each of the tethers 100 terminates with a ring 102 that is releasably engaged with one of the free ends of the cables 72.

In use, the assembly 10 is moved as needed so that a person's legs may be positioned in the saddles 78. This may be required for any number of reasons wherein a person's legs must be lifted off of a bed. The assembly 10 allows for easy for lifting of the person's legs and the control 56 may include wireless connections to allow the user, whose legs are in the assembly 10, to control the lowering and lifting of the legs. The saddles 78 are removable to allow a user to use one or two of the saddles 78.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A leg lifting assist assembly configured to engage and lift legs of a person when the person is unable to easily lift their own legs, said assembly comprising:
a base having a top side, a bottom side and a perimeter edge, said perimeter edge including a front edge, a rear edge, a first lateral edge and a second lateral edge;
a plurality of wheels being rotatably attached to and extending downwardly from said bottom side;
a post being attached to and extending upwardly from said base, said post having an upper end;
a support arm having a first end, a second end and an outer surface extending between said first and second ends, said support arm being pivotally attached to said upper end of said post, said support arm extending forward from said post, said post pivoting in a vertical plane extending through said first and second ends;
a lift mechanism being coupled to said post and said support arm being actuated to lift said second end up or down relative to said base;
a beam being attached to said support arm adjacent to said second end, said beam being elongated and having a pair of outer ends;
a pair of cables each being attached to said beam, each of said cables having an attached end and a free end; and
a pair of saddles each being configured to engage a leg, each of said free ends having one of said saddles removably attached thereto.

2. The leg lifting assist assembly according to claim 1, wherein a distance between said front and rear edges is greater than 3.0 feet.

3. The leg lifting assist assembly according to claim 1, wherein a height from a bottom of said wheels to said top side is less than 6.0 inches.

4. The leg lifting assist assembly according to claim 1, wherein said post has a height between 4.0 feet and 7.0 feet.

5. The leg lifting assist assembly according to claim 1, wherein said post is positioned between said first and second lateral edges and adjacent to said rear edge.

6. The leg lifting assist assembly according to claim 1, wherein said first end of said support arm is positioned adjacent to said post, said support arm extending at least 3.0 feet forwardly away from said post.

7. The leg lifting assist assembly according to claim 1, wherein said lift mechanism is electrically powered.

8. The leg lifting assist assembly according to claim 1, wherein said second end is positioned between said outer ends, said beam being orientated perpendicular to a longitudinal axis of said support arm extending through said first and second ends.

9. The leg lifting assist assembly according to claim 8, wherein each of said attached ends being attached removably to said beam wherein one of said cables is positioned adjacent to one of said outer ends and one of said cables is positioned adjacent to another one of said outer ends.

10. The leg lifting assist assembly according to claim 1, wherein each of said saddles comprises:
a semi-cylindrical sleeve having an open upper side and a pair of open ends, said semi-cylindrical sleeve being elongated and having upper surface having an arcuate shape extending from a first side edge to a second side edge;
a plurality of straps extending over said upper side and being configured to releasably retain a leg in said semi-cylindrical sleeve, each of said straps having a break therein forming a pair of strap ends;
a plurality of couplers, each of said straps having one of said couplers attached thereto to close said break in a respective one of said straps; and
a connector being attached to said semi-cylindrical sleeve and being removably coupled to said free end of one of said cables.

11. The leg lifting assist assembly according to claim 10, wherein said connector includes a pair of tethers extending upwardly from opposite sides of said semi-cylindrical sleeve, each of said tethers terminating with a ring being releasably engaged with one of said free ends of said cables.

12. A leg lifting assist assembly configured to engage and lift legs of a person when the person is unable to easily lift their own legs, said assembly comprising:
a base having a top side, a bottom side and a perimeter edge, said perimeter edge including a front edge, a rear edge, a first lateral edge and a second lateral edge, a distance between said front and rear edges being greater than 3.0 feet;
a plurality of wheels being rotatably attached to and extending downwardly from said bottom side, a height from a bottom of said wheels to said top side being less than 6.0 inches;
a post being attached to and extending upwardly from said base, said post having an upper end, said post having a height between 4.0 feet and 7.0 feet, said post being positioned between said first and second lateral edges and adjacent to said rear edge;
a support arm having a first end, a second end and an outer surface extending between said first and second ends, said support arm being pivotally attached to said upper end of said post, wherein said first end is positioned adjacent to said post, said support arm extending forward from said post, said post pivoting in a vertical plane extending through said first and second ends, said support arm extending at least 3.0 feet forwardly away from said post;
a lift mechanism being coupled to said post and said support arm, said lift mechanism being electrically powered and being actuated to lift said second end up or down relative to said base;
a beam being attached to said support arm adjacent to said second end, said beam being elongated and having a pair of outer ends, said second end being positioned between said outer ends, said beam being orientated perpendicular to a longitudinal axis of said support arm extending through said first and second ends;
a pair of cables, each of said cables having an attached end and a free end, each of said attached ends being attached removably to said beam wherein one of said cables is positioned adjacent to one of said outer ends and one of said cables is positioned adjacent to another one of said outer ends;
a pair of saddles each being configured to engage a leg, each of said free ends having one of said saddles removably attached thereto, each of said saddles comprising:
a semi-cylindrical sleeve having an open upper side and a pair of open ends, said semi-cylindrical sleeve being elongated and having upper surface having an arcuate shape extending from a first side edge to a second side edge;
a plurality of straps extending over said upper side and being configured to releasably retain a leg in said semi-cylindrical sleeve, each of said straps having a break therein forming a pair of strap ends;
a plurality of couplers, each of said straps having one of said couplers attached thereto to close said break in a respective one of said straps; and
a connector being attached to said semi-cylindrical sleeve and being removably coupled to said free end of one of said cables, said connector including a pair of tethers extending upwardly from opposite sides of said semi-cylindrical sleeve, each of said tethers terminating with a ring being releasably engaged with one of said free ends of said cables.
